(19) United States
(12) Patent Application Publication
(10) Pub. No.: US 2004/0181597 A1
(43) Pub. Date: Sep. 16, 2004

(54) Efficient peer-to-peer transmission in an infrastructure environment

(76) Inventors: Randy L. Ekl, Lake Zurich, IL (US); Joseph E. Phillips, Huntley, IL (US); Michael H. Retzer, Palatine, IL (US)

Correspondence Address: MOTOROLA, INC., 1303 EAST ALGONQUIN ROAD, IL01/3RD, SCHAUMBURG, IL, 60196

(21) Appl. No.: 10/388,043

(22) Filed: Mar. 13, 2003

(51) Int. Cl. G06F 15/16

(52) U.S. Cl. 709/227

(57) ABSTRACT

In a first embodiment, an infrastructure device (106) receives a message identifying a source station address (102) and a destination station address (104). The infrastructure device transmits an acknowledgement message to the source station address within a first time period, and transmits the message to the destination station address only if an acknowledgement message was not transmitted by the destination station within a second time period. In a second embodiment, if the message has a designated bit set, the infrastructure device discards the message, and the destination device transmits an acknowledgement message to the source station within the first time period.

### FIELD OF THE INVENTION

This invention relates generally to an efficient peer-to-peer transmission in an infrastructure environment, and particularly to a method of efficiently communicating with another wireless user within close proximity.

### BACKGROUND OF THE INVENTION

Current wireless systems 100, most notably 802.11 wireless local area network (“WLAN”) systems, operate in an infrastructure mode; in other words, as illustrated in FIG. 1, all transmissions from mobile stations 102, 104 are directed solely to an infrastructure device 106 (e.g., access point, base station, or the like). In an infrastructure configuration, the mobile stations 102, 104 communicate with each other through the infrastructure device 106. It should be noted that the coverage area of the infrastructure device 106 is depicted by circle 108, and the coverage area of the first mobile station 102 is depicted by circle 110. It should also be noted that the examples used throughout the discussion depict mobile station 102 as the source mobile station, and mobile station 104 as the destination mobile station; however, each mobile station 102, 104 is capable of being both a source and/or a destination mobile station.

As illustrated in FIGS. 2 and 3, the source mobile station 102 transmits a message 200 having a destination address matching that of the destination mobile station 104 on the air interface. This message is received by infrastructure device 106. Upon receipt of the message 200, the infrastructure device 106 transmits an acknowledgement message 202 to the source mobile station 102 during a short inter-frame space (“SIFS”) time 300, at which time, the source mobile station 102 discards the message. As known to those individuals skilled in the art, the SIFS time 300 typically follows the transmission of a message, in which the device receiving the message acknowledges the message; each device (e.g., mobile stations and infrastructure device) in the system waits the SIFS time 300 after a message is transmitted in order for the intended recipient of the message to transmit an acknowledgement message during a contention-free period.

In addition to waiting the SIFS time 300, each device in the system also waits a distributed inter-frame space (“DIFS”) time 302 before transmitting in an idle medium. Thus, the infrastructure device 106 waits for the DIFS time 302 to elapse, and transmits the message 200′ on the air interface. The destination mobile station 104 receives this message. It is important to note that message 200 and message 200′ are identical except (a) message 200 is transmitted by the source mobile station 102 and message 200′ is a repeated copy of message 200 transmitted by the infrastructure device 106; and (b) message 200 has a bit set to indicate that it is transmitted ‘to’ the infrastructure device 106, and message 200′ has a bit set to indicate that it is transmitted ‘from’ the infrastructure device 106. Upon receipt of the message 200′, the destination mobile station 104 transmits an acknowledgement message 204 to the infrastructure device 106 during the SIFS time 300 following message 200′, at which time, the infrastructure device 106 discards the message 200.

One disadvantage resulting from the manner in which the mobile stations 102, 104 currently communicate with each other when operating in an infrastructure configuration is that the load on the air interface in increased. In the infrastructure configuration, the system 100 must transmits two copies of the same message 200, 200′ on the air interface: once from the source mobile station 102 to the infrastructure device 106, and once from the infrastructure device 106 to the destination mobile station 104. Transmitting the message 200 back on the air interface is inefficient from a resource utilization standpoint, as it uses the air interface bandwidth twice.

Another disadvantage resulting from the manner in which the mobile stations 102, 104 currently communicate with each other is time inefficiency. As illustrated in FIG. 3, it takes twice as long for the destination mobile station 104 to receive the message 200 since it 104 has to wait for the infrastructure device 106 to transmit the message 200′.

Yet another disadvantage resulting from the manner in which the mobile stations 102, 104 currently communicate with each other is from a reliability standpoint. Either hop (transmitted from the source mobile station 102, received by infrastructure device 106, or transmitted from the infrastructure device 106, received by the destination mobile station 104) could be less than perfectly reliable; therefore the overall reliability of the delivery of the message 200 is decreased.

Currently, in an infrastructure configuration, a message, however, cannot simply be transmitted from the source mobile station 102 to the destination mobile station 104 within the bounds of the existing protocols. Thus, there exists a need for a method to allow efficient, peer-to-peer transmissions in an infrastructure environment.

### BRIEF DESCRIPTION OF THE FIGURES

A preferred embodiment of the invention is now described, by way of example only, with reference to the accompanying figures in which:

FIG. 1 (prior art) illustrates a plurality of mobile stations operating within range of an infrastructure device;

FIG. 2 (prior art) illustrates a message sequence flow diagram depicting the communication between a first mobile station and a second mobile station in an infrastructure configuration;

FIG. 3 (prior art) illustrates a timing diagram corresponding to the message sequence flow diagram of FIG. 2;

FIG. 4 illustrates a flowchart from the perspective of the infrastructure device in accordance with a first embodiment of the present invention;

FIG. 5 illustrates a flowchart from the perspective of a destination mobile station in accordance with the first embodiment of the present invention;

FIG. 6 illustrates a message sequence flow diagram depicting the communication between the source mobile station and the destination mobile station in an infrastructure configuration in accordance with the first embodiment of the present invention;

FIG. 7 illustrates a timing diagram corresponding to the message sequence flow diagram of FIG. 6 in accordance with the first embodiment of the present invention;

FIG. 8 illustrates a flowchart from the perspective of a source mobile station in accordance with a second embodiment of the present invention;

FIG. 9 illustrates a flowchart from the perspective of the destination mobile station in accordance with the second embodiment of the present invention;

FIG. 10 illustrates a message sequence flow diagram depicting the communication between the source mobile station and the destination mobile station in an infrastructure configuration in accordance with the second embodiment of the present invention; and

FIG. 11 illustrates a timing diagram corresponding to the message sequence flow diagram of FIG. 10 in accordance with the second embodiment of the present invention.

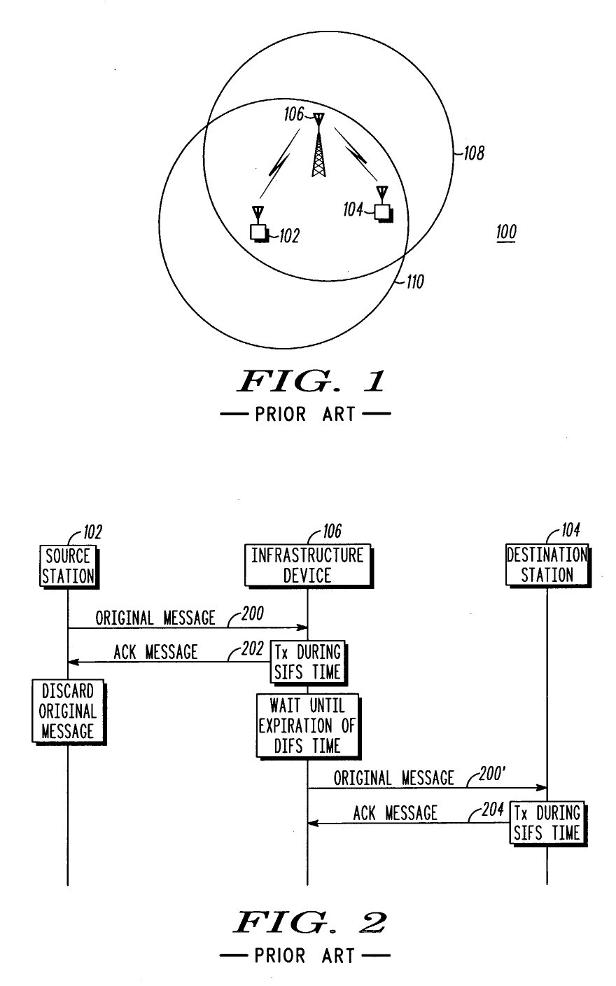

### DETAILED DESCRIPTION OF THE PREFERRED EMBODIMENT

The present invention provides a method to allow efficient, peer-to-peer transmissions in an infrastructure environment. The present invention discloses a method in which the destination mobile station 104 acknowledges the message 200 transmitted from the source mobile station 102 prior to the infrastructure device 106 transmitting the message 200′ on the air interface. The present invention further discloses a method in which the destination mobile station 104 acknowledges the message 200 transmitted from the source mobile station 102 directly (i.e., within the SIFS time corresponding to the message 200). Thus, the present invention reduces the load on the air interface and/or infrastructure device 106, reduces packet delay, reduces collisions and retries, and improves the overall reliability of the system 100.

It will be appreciated that for simplicity and clarity of illustration, elements shown in the figures have not necessarily been drawn to scale. For example, the dimensions of some of the elements are exaggerated relative to each other. Further, where considered appropriate, reference numerals have been repeated among the figures to indicate identical elements.

Let us first discuss the first embodiment of the present invention in which the destination mobile station 104 acknowledges the message 200 transmitted from the source mobile station 102 to the infrastructure device 106 prior to the infrastructure device 106 transmitting the message 200′ to the destination mobile station 104 on the air interface. For ease of explanation, it is important to note that in the following examples, message 200 is not needed by any other destination mobile station other than the destination mobile station 104 (i.e., message 200 is not going to multiple destination stations) and the message 200 is not being logged in the infrastructure device 106.

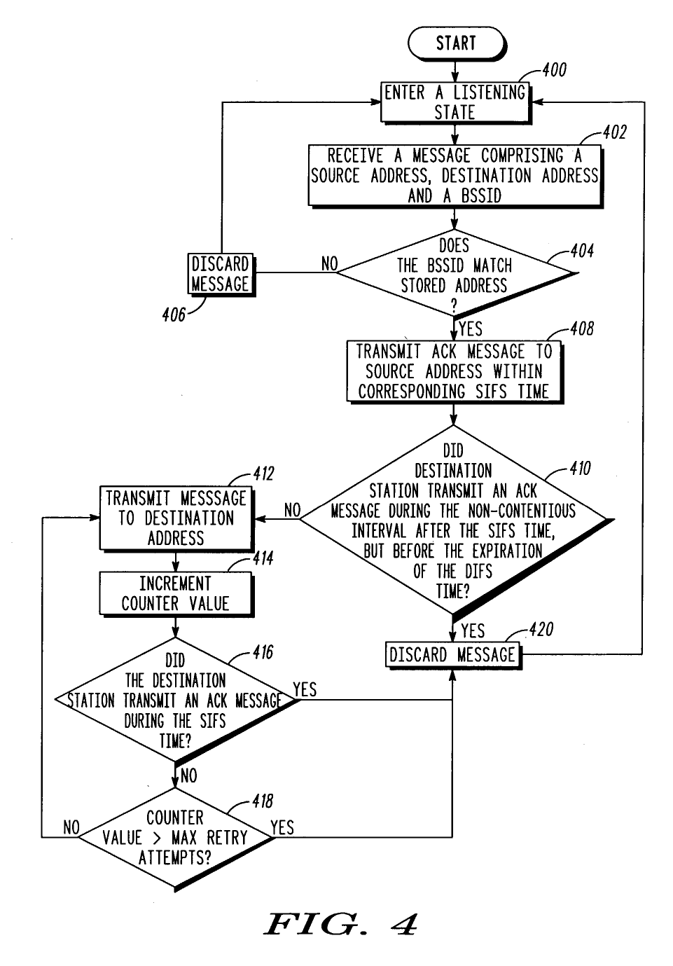

FIG. 4 illustrates a flowchart from the perspective of the infrastructure device 106 in accordance with the first embodiment of the present invention. As illustrated, the infrastructure device 106 is always “listening” for messages being transmitted on the air interface (step 400). For purposes of the present invention, it is assumed that each message transmitted on the air interface comprises an address of a source mobile station, an address of a destination mobile station, and an address of an infrastructure device. Upon receipt of a message 200 (step 402), the infrastructure device 106 determines whether the address of the infrastructure device in the message 200 matches its stored address (step 404). If the address of the infrastructure device in the message 200 does not match the address stored at the infrastructure device 106, the infrastructure device 106 discards the message 200 (step 406). If the address of the infrastructure device in the message 200, however, does match the address stored at the infrastructure device 106, the infrastructure device 106 transmits an acknowledgement message 202 to the source mobile station 102 within the SIFS time 300 corresponding to message 200, as commonly known to individuals skilled in the art (step 408).

After transmitting the acknowledgement message 202 to the source mobile station 102, the infrastructure device 106 determines if the destination mobile station 104 transmitted an acknowledgement message to the infrastructure device 106 during a non-contentious interval of time after the SIFS time 300, but before the expiration of the DIFS time 302 (step 410). If an acknowledgement message was not transmitted by the destination mobile station 104 prior to expiration of the DIFS time 302, the infrastructure device 106 transmits the message 200′ to the destination mobile station 104 (step 412).

As typically known to those skilled in the art, upon transmission of the message 200′ to the destination mobile station 104, the infrastructure device 106 increments a counter value (not shown; step 414); the counter value represents the number of times the message 200′ has been transmitted by the infrastructure device 106, without receiving acknowledgement from destination mobile station 104. After transmitting the message 200′, the infrastructure device 106 determines if the destination mobile station 104 transmitted an acknowledgment message to the infrastructure device 106 within the SIFS time corresponding to message 200′ (step 416). The infrastructure device 106 continues to re-transmit the message 200′ until the destination mobile station 104 transmits an acknowledgement message to the infrastructure device 106 within the SIFS time corresponding to message 200′ (step 416), or until the counter value equals the maximum number of retry attempts (step 418), whichever is sooner. The infrastructure device 106 then discards the message (step 420) and waits to receive a new message.

If, however, an acknowledgement message 204 was transmitted by the destination mobile station 104 during the non-contentious interval of time after the SIFS time 300 corresponding to message 200, but before the expiration of the DIFS time 302 (step 410), the infrastructure device 106 discards the message 200 without transmitting the message 200′ to the destination mobile station 104 in accordance with the present invention (step 420). Thus, in the first embodiment of the present invention, the intelligence is in the infrastructure device 106 to determine if the message 200 needs to be transmitted (repeated) back on the air interface to the destination mobile station 104.

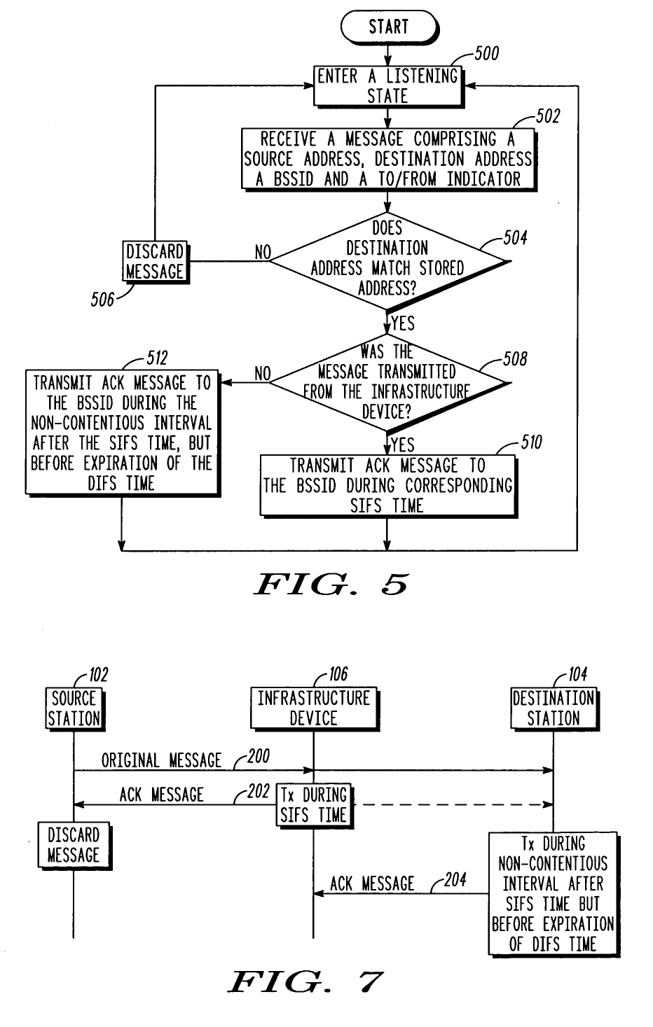

Now let us look at the first embodiment of the present invention from the perspective of the mobile station 104. As illustrated in FIG. 5, each mobile station 102, 104, like the infrastructure device 106, is always “listening” to the messages being transmitted on the air interface (step 500). Upon receipt of a message (step 502), the mobile station 104 determines if the destination address of the message matches its address (step 504). If the destination address of the message does not match the address of the mobile station 104, the mobile station 104 discards the message (step 506), and continues “listening” for messages being transmitted on the air interface (step 500).

If the destination address of the message, however, does match the address of the mobile station 104, the mobile station 104 determines whether the message was transmitted ‘from’ the infrastructure device 106 or ‘to’ the infrastructure device 106 (step 508). If the message was transmitted ‘from’ the infrastructure device 106 (i.e., mobile station 104 received message 200′), the mobile station 104 transmits an acknowledgment message 204 to the infrastructure device 106 identified in the message during the corresponding SIFS time (step 510), as illustrated in FIG. 3. If the message was transmitted ‘to’ the infrastructure device 106 (i.e., mobile station 104 received message 200), the mobile station 104 transmits an acknowledgement message 204 to the infrastructure device 106 in the first non-contentious interval after the corresponding SIFS time 300 following message 200, but before expiration of the corresponding DIFS time 302 in accordance with the first embodiment of the present invention (step 512), as illustrated in FIG. 6. After transmitting the acknowledgement message 204 to the infrastructure device 106, the destination mobile station 104 processes the message accordingly. Thus, in the first embodiment of the present invention, the intelligence is also in the destination mobile station 104 to transmit an acknowledgement message 204 to the infrastructure device 106 in the first non-contentious interval after the SIFS time 300 corresponding to message 200, but before expiration of the corresponding DIFS time 302 when the message received by the destination mobile station 104 was transmitted ‘to’ the infrastructure device 106.

FIG. 7 illustrates an example of a message sequence flow diagram depicting the communication between the source mobile station 102 and the destination mobile station 104 in an infrastructure configuration in accordance with the first embodiment of the present invention. The present invention assumes that the source mobile station 102, the destination mobile station 104, and the infrastructure device 106 are functioning properly, and that the source mobile station 102 and the destination mobile station 104 are registered and associated with the infrastructure device 106. In this example, the source mobile station 102 transmits the message 200 having a destination address matching the address of the destination mobile station 104 and having an infrastructure address (i.e., basic service set identification (“BSSID”)) matching the address of the infrastructure device 106. Both the infrastructure device 106 and the destination mobile station 104 receive the message 200. Upon receipt of the message 200 by the infrastructure device 106, the infrastructure device 106 immediately transmits an acknowledgement message 202 to the source mobile station 102 within the SIFS time 300; because of the proximity of the devices, it is likely that the destination mobile station 104 will also receive the acknowledgement message 202 transmitted by the infrastructure device 106 to the source mobile station 102, however, it is not necessary that the destination mobile station 104 receives this message 202. Once the source mobile station 102 receives the acknowledgement message 202 from the infrastructure device 106, the source mobile station 102 typically discards the message 200.

Upon receipt of the message 200 by the destination mobile station 104, the destination mobile station 104 transmits an acknowledgement message 204 to the infrastructure device 106 in the first non-contentious interval after the corresponding SIFS time 300, but before expiration of the corresponding DIFS time 302. Since the destination mobile station 104 transmitted the acknowledgement message 204 to the infrastructure device 106 in the first non-contentious interval after the SIFS time 300 corresponding to message 200, but before expiration of the corresponding DIFS time 302, the infrastructure device 106 discards the message without transmitting message 200′ to the destination mobile station 104.

The example described with respect to FIG. 7 is further illustrated with the timing diagram illustrated in FIG. 6. The reduction in the load on the air interface as a result of the present invention is clearly illustrated when compared to the timing diagram depicting the prior art illustrated in FIG. 3.

Thus, as a result of the first embodiment of the present invention, the load on the air interface is reduced because the infrastructure device 106 selectively transmits (repeats) message 200′ to the destination mobile station 104; transmission of an acknowledgement message 204 to the infrastructure device 106 by the destination mobile station 104 in the first non-contentious interval after the SIFS time 300 corresponding to message 200 (i.e., the message transmitted by the source mobile station 102), but before expiration of the corresponding DIFS time 302 signals the infrastructure device 106 not to transmit (repeat) message 200′ on the air interface in accordance with the first embodiment of the present invention. Moreover, the packet delay is reduced because the destination mobile station 104 receives and acknowledges the message 200 upon transmission of the message 200 by the source mobile station 102, and possible collisions and retries are reduced because the number of times the message 200 is transmitted on the air interface is reduced. Additionally, the reliability of the message delivery improves, as the probability that one message and two acknowledgement messages being successfully transferred over the air is greater than the probability of two messages and two acknowledgement messages being successfully transferred over the air.

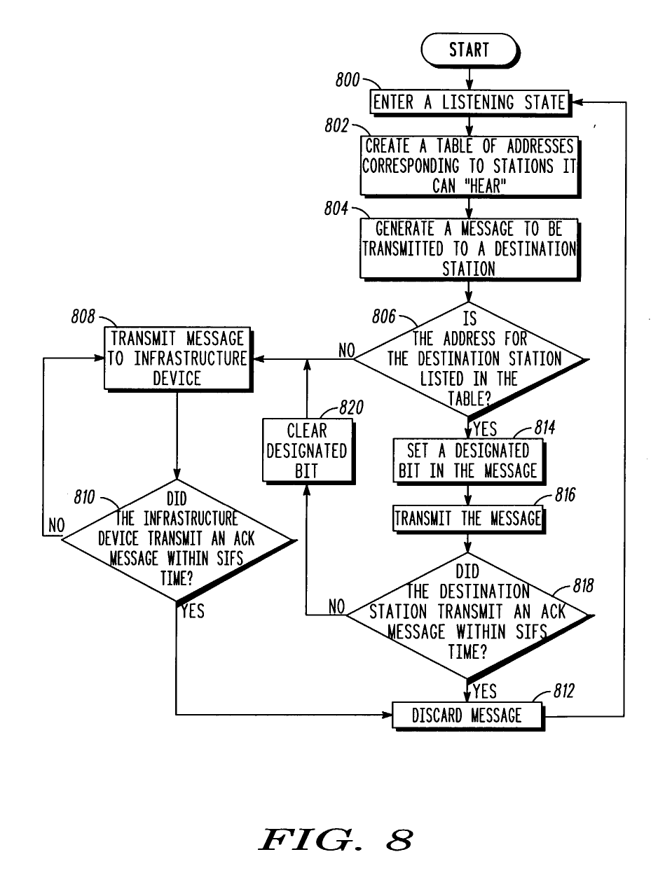

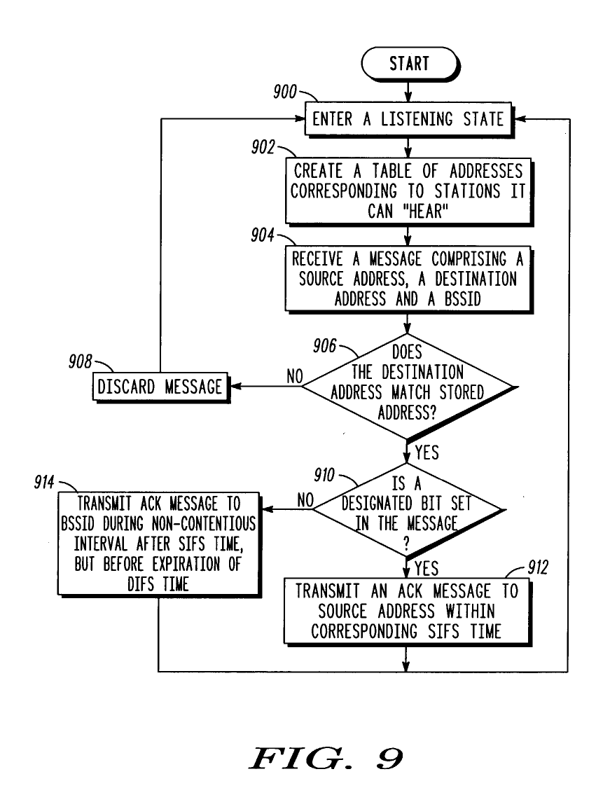

Let us now turn the discussion to a second embodiment of the present invention as illustrated in FIGS. 8, 9, 10, and 11. Since mobile stations are always “listening” to messages being transmitted on the air interface (step 800), each mobile station 102, 104 builds a table of the other mobile stations it can “hear” (step 802; i.e., builds a table of other mobile stations from which it received messages). For purposes of the present invention, it is assumed that if a first mobile station can receive messages from a second mobile station, the second mobile station can also receive messages from the first mobile station. Thus, when a source mobile station 102 generates a message 200 with the destination address matching that of the destination mobile station 104 (step 804), the source mobile station 102 determines whether the destination mobile station 104 is listed in its table (step 806).

If the destination mobile station 104 is not listed in the table created by the source mobile station 102, the source mobile station 102 transmits the message 200 to the infrastructure device 106 (step 808) until the infrastructure device 106 transmits an acknowledgement message within the corresponding SIFS time (step 810), at which time the source mobile station 102 discards the message 200 (step 812).

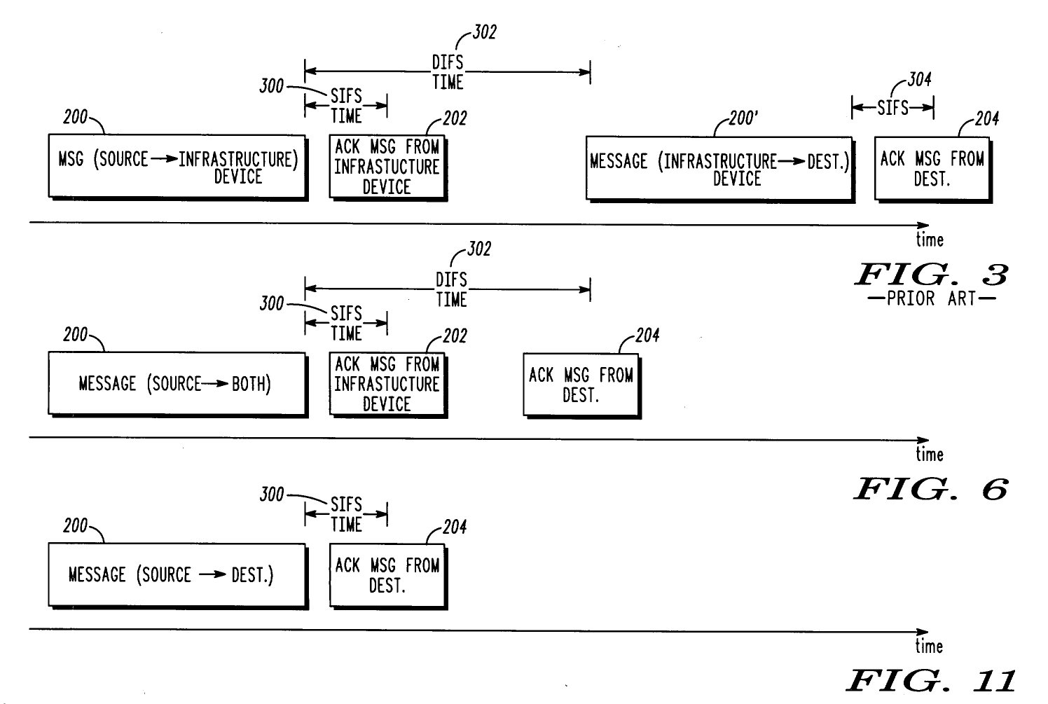

If the destination mobile station 104, however, is listed in the table created by the source mobile station 102, the source mobile station 102 sets a designated bit (not shown) in the message 200 (step 814) and transmits the message 200 (step 816). If the destination mobile station 104 transmits an acknowledgement message 204 to the source mobile station 102 within the SIFS time 300 corresponding to the message 200 (step 818), the source mobile station 102 discards the message 200 (step 812) and continues to “listen” to messages being transmitted on the air interface (step 800) and updates its table, if necessary. If, however, the destination mobile station 104 does not transmit an acknowledgement message 204 to the source mobile station 102 within the SIFS time 300 corresponding to the message 200, the source mobile station 102 assumes that the destination mobile station 104 did not “hear”/receive the message 200 (possibly because the destination mobile station 104 moved further away from the source mobile station 102). As a result, the source mobile station 102 clears the designated bit from the message 200 (step 820) and re-transmits the message 200. Preferably, the source mobile station 102 removes the address of the destination mobile station 104 from its table when an acknowledgement message is not received. Once the source mobile station 102 re-transmits the message 200 without the designated bit set, it waits to receive an acknowledgement message 202 from the infrastructure device 106. Since the designated bit is not set, the infrastructure device 106 transmits an acknowledgement message 202 to the source mobile station 102 within the SIFS time 300 corresponding the message 200, at which point, the process is carried out accordingly, such as described in FIGS. 2 and 3 or FIGS. 4 and 6. Thus, it is important to note that the infrastructure device 106 does not transmit an acknowledgement message 202 to the source mobile station 102 upon receipt of the message 200 during the corresponding SIFS time 300 when the designated bit is set in accordance with the second embodiment of the present invention.

From the perspective of the destination mobile station 104, the destination mobile station 104 is “listening” for messages being transmitted on the air interface (step 900), and like the source mobile station 102, is building a table of other mobile stations it can “hear” (step 902). Upon receipt of a message 200 (step 904), the destination mobile station 104 determines if the destination address of the message 200 matches its stored address (step 906). If the destination address of the message 200 does not match the address of the destination mobile station 104, the destination mobile station 104 discards the message 200 (step 908), and continues “listening” for messages being transmitted on the air interface (step 900). If the destination address of the message 200, however, does match the address of the destination mobile station 104, the destination mobile station 104 determines if the designated bit is set in the message 200 (step 910).

When the designated bit is set in the message 200, the destination mobile station 104 transmits an acknowledgement message 204 to the source mobile station 102 identified in the message 200 within the SIFS time 300 immediately following the message 200 (step 912); otherwise, if the designated bit is not set in the message 200, the destination mobile station 104 transmits an acknowledgement message 204 to the infrastructure device 106 identified in the message 200 during the non-contentious interval of time after the corresponding SIFS time 300, but before expiration of the DIFS time 302 (step 914) as described with respect to the first embodiment of the present invention (FIGS. 5 and 6), or during the SIFS time following message 200′ as described with respect to the prior art (FIGS. 2 and 3).

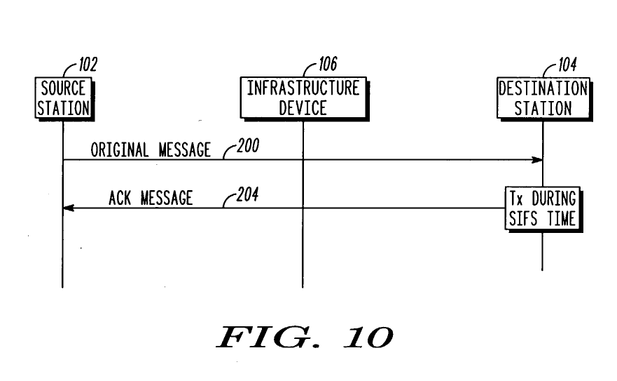

FIG. 10 illustrates an example of a message sequence flow diagram depicting the communication between the source mobile station 102 and the destination mobile station 104 in accordance with the second embodiment of the present invention. As above, the present invention assumes that the source mobile station 102, the destination mobile station 104, and the infrastructure device 106 are functioning properly, and that the source mobile station 102 and the destination mobile station 104 are registered and associated with the infrastructure device 106. As illustrated, the source mobile station 102 creates a table of stations that it can “hear”; in this example, the table created by the source mobile station 102 comprises the destination mobile station 104. The source mobile station 102 generates a message 200 having a destination address matching the address of the destination mobile station 104. Since the destination mobile station 104 is listed in the table created by the source mobile station 102, the source mobile station 102 sets a designated bit in the message 200 and transmits the message 200. In this example, the infrastructure device 106 “hears” (receives) the message 200 transmitted by the source mobile station 102, determines that the BSSID matches its address (if present), and identifies that the designated bit is set in the message 200; as a result of the designated bit being set in the message 200, the infrastructure device 106 discards the message 200.

The destination mobile station 104 also “hears” (receives) the message 200 transmitted by the source mobile station 102, determines that the destination address of the message 200 matches its address, and identifies that the designated bit in the message 200 is set; as a result of the designated bit being set in the message 200, the destination mobile station 104 transmits an acknowledgement message 204 within the SIFS time 300 immediately following the message 200, and processes the message 200 accordingly. Upon receipt of the acknowledgement message 204 from the destination mobile station 104, the source mobile station 102 discards the message 200.

The example described with respect to FIG. 10 is further illustrated with the timing diagram illustrated in FIG. 11. The reduction in the load on the air interface as a result of the present invention is clearly illustrated when compared to the timing diagram illustrated in FIG. 3.

In a second example of the second embodiment of the present invention, the destination mobile station 104 does not “hear” (receive) the message 200 transmitted by the source mobile station 102, and as a result, the destination mobile station 104 fails to transmit the acknowledgement message 204 to the source mobile station 102 within the corresponding SIFS time 300. When the destination mobile station 104 fails to transmit the acknowledgement message 204 to the source mobile station 102 within the corresponding SIFS time 300, the source mobile station 102 removes the address of the destination mobile station from its table, clears the designated bit from the message 200 and re-transmits the message 200. When the source mobile station 102 re-transmits the message 200 without the designated bit set, the infrastructure device 106, upon receipt of the message 200, transmits an acknowledgement message 202 to the source mobile station 102 within the SIFS time 300 corresponding to the message 200 and processes the message 200 accordingly, for example, as described in the first embodiment of the present invention (FIGS. 4 and 6), or as described in the background (FIGS. 2 and 3).

As in the first embodiment, the second embodiment of the present invention reduces the load on the air interface is because the source mobile station 102 can possibly communicate directly to the destination mobile station 104, thus only requiring one acknowledgement message to be transmitted on the air interface. Further, the load on the infrastructure device 106 is reduced because the infrastructure device 106 does not process messages that have the designated bit set. Moreover, the second embodiment of the present invention reduces the packet delay because the destination mobile station 104 receives and acknowledges the message 200 upon transmission of the message 200 by the source mobile station 102. Also, the system reliability further improves, because now there is only one message 200 and one acknowledgement message 204, reduced from one message 200 and two acknowledgement messages 202, 204 as in the first embodiment, and two messages 200, 200′ and two acknowledgement messages 202, 204 as in the prior art.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

We claim:

1. In an infrastructure environment comprising a source station, a destination station, and an infrastructure device, a method comprising the steps of:
receiving a message identifying a source station address and a destination station address;
transmitting a first acknowledgement message to the source station address within a first time period; and
transmitting the message to the destination station address only if a second acknowledgement message was not transmitted by the destination station within a second time period.

2. The method of claim 1 further comprising the step of discarding the message if the second acknowledgement message was transmitted by the destination station within the second time period.

3. The method of claim 1 further comprising the step of waiting a third time period prior to the step of transmitting the message to the destination station.

4. The method of claim 1 wherein the message further identifies an infrastructure address, and further comprising the step of determining that the infrastructure address matches a stored address.

5. In an infrastructure environment comprising a source station, a destination station, and an infrastructure device, a method comprising the steps of:
receiving a message identifying a source station address and a destination station address;
transmitting a first acknowledgement message to the source station address within a first time period;
determining whether a second acknowledgement message was transmitted by the destination station within a second time period;
if the second acknowledgement message was not transmitted by the destination station within the second time period, transmitting the message to the destination station address after the second time period expires; and
if the second acknowledgement message was transmitted by the destination station within the second time period, discarding the message without transmitting the message to the destination station address.

6. In an infrastructure environment comprising a source station, a destination station, and an infrastructure device, a method comprising the steps of:
receiving a message from the source station, wherein the message identifies a destination station address and an infrastructure address;
if the destination station address does not match a stored address, discarding the message; and
if the destination station address does match the stored address, waiting a first time period, and transmitting an acknowledgement message to the infrastructure address within a second time period.

7. In an infrastructure environment comprising a source station, a destination station, and an infrastructure device, a method comprising the steps of:
generating a message having a designated bit, wherein the message identifies a destination station address;
determining whether the destination station address is stored in memory;
if the destination station address is stored in memory, setting the designated bit in the message; otherwise, resetting the designated bit; and
transmitting the message.

8. The method of claim 7 further comprising storing an address into the memory when a message is received from the source station.

9. The method of claim 7 further comprising the steps of:
determining whether an acknowledgement message was transmitted within a first time period;
if the acknowledgment message was transmitted within the first time period, discarding the message; otherwise, resetting the designated bit and retransmitting the message.

10. The method of claim 9 further comprising the step of removing an address from memory if the acknowledgement message was not transmitted within the first time period.

11. In an infrastructure environment comprising a source station, a destination station, and an infrastructure device, a method comprising the steps of:
receiving a message having a designated bit, wherein the message identifies a source station address;
if the designated bit is set in the message, discarding the message; and
if the designated bit is not set in the message, transmitting an acknowledgement message to the source station address within a first time period.

12. In an infrastructure environment comprising a source station, a destination station, and an infrastructure device, a method comprising the steps of:
receiving a message having a designated bit, wherein the message identifies a source station address, a destination station address, and an infrastructure address;
determining whether the destination station address matches a stored address;
if the destination station address does not matches a stored address, discarding the message; and
if the destination station address matches the stored address, transmitting an acknowledgement message to the source station address within a first time period when the designated bit is set; otherwise, transmitting the acknowledgement message to the infrastructure address within a second time period.

13. The method of claim 12 wherein the first time period begins before the second time period.

14. The method of claim 12 further comprising storing the source station address into a memory.
